(19) United States
(12) Patent Application Publication
(10) Pub. No.: US 2025/0094012 A1
(43) Pub. Date: Mar. 20, 2025

(54) DISPLAY CONTROL DEVICE AND DISPLAY CONTROL METHOD

(71) Applicant: SHARP KABUSHIKI KAISHA, Sakai City (JP)

(72) Inventor: AKIRA OGAWA, Sakai City (JP)

(21) Appl. No.: 18/883,133

(22) Filed: Sep. 12, 2024

(30) Foreign Application Priority Data
Sep. 20, 2023 (JP) 2023-152625

(51) Int. Cl. G06F 3/0481; H04N 1/00

(52) U.S. Cl. CPC G06F 3/0481; H04N 1/00469; H04N 1/00472; H04N 1/0048; H04N 1/00506

(57) ABSTRACT

A display control device includes a display that displays a first display screen including an object that is operable, an operation inputter that receives an operation on the object, and one or more controllers, wherein when detecting an event in a state where the first display screen is displayed, the one or more controllers determine a size of a second display screen including a message based on the event in accordance with whether it is necessary to operate the object on the first display screen, and perform control of displaying the second display screen on the display such that the second display screen is superimposed on the first display screen.

### TECHNICAL FIELD

The disclosure relates to a display control device and the like.

### BACKGROUND ART

For example, there is known an invention in which a message regarding a notification item is displayed to a user.

### SUMMARY

### Technical Problem

An object of the disclosure is to provide a display control device and the like capable of displaying a user interface that is easy for a user to understand, for example, when a message is displayed to the user based on an event.

### Solution to Problem

A display control device according to the disclosure includes a display that displays a first display screen including an object that is operable, an operation inputter that receives an operation on the object, and one or more controllers, wherein when detecting an event in a state where the first display screen is displayed, the one or more controllers determine a size of a second display screen including a message based on the event in accordance with whether it is necessary to operate the object on the first display screen, and perform control of displaying the second display screen on the display such that the second display screen is superimposed on the first display screen.

A display control method according to the disclosure is a display control method in a display control device including a display that displays a first display screen including an object that is operable, an operation inputter that receives an operation on the object, and one or more controllers, the display control method including, when an event is detected in a state where the first display screen is displayed, determining a size of a second display screen including a message based on the event in accordance with whether it is necessary to operate the object on the first display screen, and performing control of displaying the second display screen on the display such that the second display screen is superimposed on the first display screen.

### Advantageous Effects of Invention

According to the disclosure, it is possible to provide a display control device and the like capable of displaying a user interface that is easy for a user to understand when a message is displayed to the user based on an event.

### BRIEF DESCRIPTION OF DRAWINGS

FIG. 1 is a diagram for describing an entirety of an image forming device according to a first embodiment.

FIG. 2 is a diagram for describing a hardware configuration of the image forming device according to the first embodiment.

FIG. 3 is a diagram for describing a software configuration according to the first embodiment.

FIG. 4 is a diagram illustrating an example of a message management table according to the first embodiment.

FIG. 5 is a diagram illustrating an example of a message control table according to the first embodiment.

FIG. 6 is a diagram for describing an example of a basic configuration of a display screen according to the first embodiment.

FIG. 7 is a diagram for describing an operation of display processing according to the first embodiment.

FIG. 8A and FIG. 8B are diagrams for describing a display screen example according to the first embodiment.

FIG. 9 is a diagram for describing a display screen example according to the first embodiment.

FIG. 10 is a diagram for describing an operation of display processing according to a second embodiment.

FIG. 11A and FIG. 11B are diagrams for describing a display screen example according to a third embodiment.

### DESCRIPTION OF EMBODIMENTS

Embodiments of the disclosure will be described below with reference to the drawings. Note that the embodiments described below are embodiments that provide the disclosure, and the content of the disclosure is not to be interpreted as being limited based on the description below.

An image forming device will be described as an example of a typical display control device. For example, an image forming device including a display input device such as an operation panel having a touch function can display an operation state of the device, an operation button for receiving an operation instruction from a user, various messages, and the like, on a display screen of the display input device.

However, a recent image forming device has multiple functions and simultaneously operate a plurality of tasks (a plurality of processing operations), which increases the amount of information displayed on an operation panel (for example, a display device) connected to the image forming device. Such an image forming device displays a large amount of information. The image forming device may display a message on a display screen in a pop-up manner to notify a user. When the message is displayed in a pop-up manner, the user cannot select an operation button or the like even when the operation button or the like has been displayed on an immediately previous display screen.

Moreover, in recent years, the size of a display device of a low-cost image forming device has been reduced. The amount of information that can be displayed in a small display device is limited. Thus, in most cases, a method is used in which a fixed message display region is not provided in a display area and a message is displayed in a banner or displayed in a pop-up manner.

Up until now, in a display control device, a display screen that has been displayed before message display remains to be displayed as it is, and the message is, for example, displayed in a banner or displayed in a pop-up manner on the display screen.

In this case, even if a restriction is imposed to make some or all of objects (for example, operation buttons, selection items, and the like) displayed on the display screen inoperable during the message display, there is a problem in that the user cannot intuitively recognize that operations of the objects are restricted due to the message display.

In addition, when the user actually performs an operation such as selecting an object in such a situation and cannot get an expected result, for example, the object being incapable of being operated, there is a problem in that it is difficult for the user to determine whether such a situation is caused by the restriction during the message display or by other reasons.

As described above, the disclosure has been made to solve the above-described problem. When an event requiring message display occurs in a state where a screen for receiving a user operation is displayed, whether the message is displayed in a full-screen mode or displayed so as not to cover a part of the operation screen is controlled in accordance with whether it is necessary to operate other than the message display area. This allows the user to easily recognize an operation that can be performed during the message display.

A case where the image forming device according to the disclosure is applied to an image forming device 10 will be described below with reference to the accompanying drawings.

### 1. First Embodiment

A first embodiment will be described. In the first embodiment, an image forming device will be described as an example of a device to which the display control device according to the disclosure is applied. Note that a configuration to which the display control device according to the disclosure can be applied is not limited to an image forming device as long as a message can be displayed. Examples of the display control device may include a home electric appliance such as a television or a microwave including a display, and a machine such as a car navigation system or an automatic teller machine. The display control device may be an information processing device used by an individual, such as a smartphone, a smartwatch, or a tablet.

### 1.1 Entirety of System

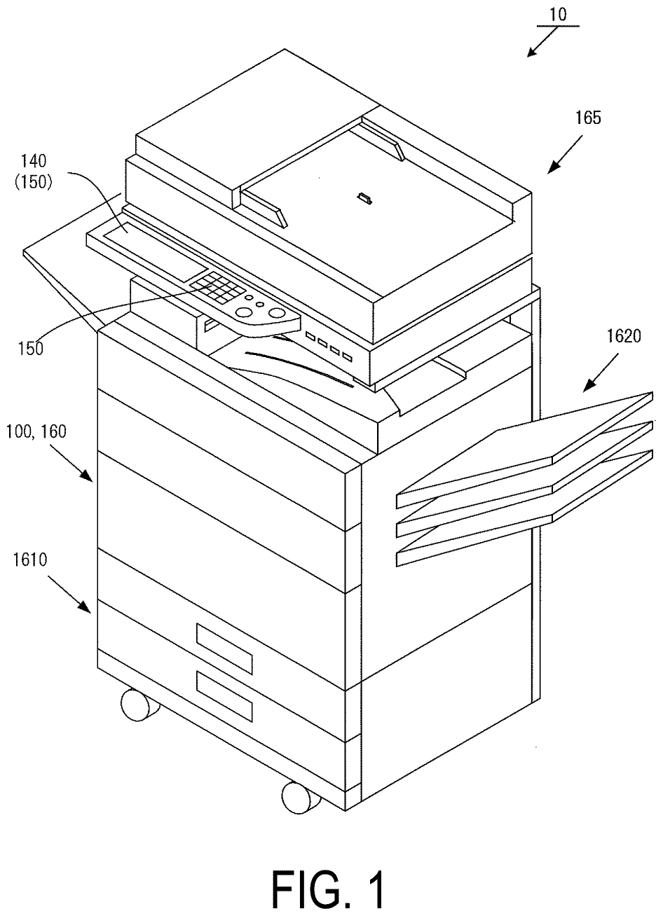

An overview of the image forming device 10 will be described. FIG. 1 is an external perspective view schematically illustrating the image forming device 10.

The image forming device 10 can implement a typical copy function, FAX function, and scanner function. For example, the image forming device 10 can execute a copy job by executing a copy function.

The copy job will be briefly described below. First, a document is places at an image scanner 165, and a copy operation is performed on an operation inputter 150. The user can confirm the set document size, paper size, and copy settings (for example, single-sided, double-sided, or 2in1 setting) on a display 140.

When the user performs a copy start operation from the operation inputter 150, copy processing is executed. Specifically, the image scanner 165 scans a document placed by the user. A controller 100 generates image data from the document scanned by the image scanner 165.

An image former 160 described below generates an image based on the image data on a sheet conveyed from a sheet tray 1610, and outputs the sheet from an output tray 1620. In the present embodiment, the sheet is recording paper or a recording sheet on which an image is formed. The sheets include not only ordinary plain paper but also various paper media such as thick paper and glossy paper, as well as a film as long as an image can be formed thereon.

In the image forming device 10 according to the present embodiment, the size of the display 140 may be small. For example, in recent years, a large operation panel such as an 8-inch or 10-inch operation panel is used as the display 140 of the image forming device 10 in many cases for the purpose of improving operability. The image forming device 10 according to the present embodiment is expected to exert the effect of the disclosure particularly when an operation panel smaller than that of a typical image forming device, such as a 4-inch or 5-inch operation panel, is employed.

### 1.2 Hardware Configuration

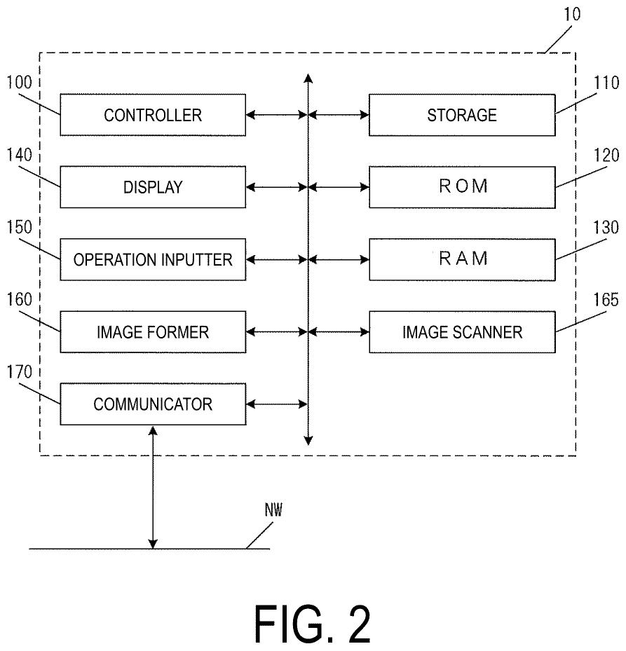

An example of a hardware configuration of the image forming device 10 will be described below with reference to FIG. 2.

As illustrated in FIG. 2, the image forming device 10 includes the controller 100, a storage 110, a ROM 120, a RAM 130, the display 140, the operation inputter 150, the image former 160, the image scanner 165, and a communicator 170. The storage 110, the ROM 120 and the RAM 130 serve as storage devices (storages).

The controller 100 controls an entirety of the image forming device 10. The controller 100 implements various functions by reading and executing various programs stored in one or multiple storage devices (for example, the storage 110 and the ROM 120). The controller 100 may be implemented by one or multiple control devices/arithmetic devices (such as a Central Processing Unit (CPU), a System on a Chip (SoC)). The controller 100 may include a control circuit.

The storage 110 is a non-volatile storage device capable of storing programs and data. For example, the storage 110 may include a storage device such as a Hard Disk Drive (HDD) or a Solid State Drive (SSD). The storage 110 may be configured as a USB memory stick that can be connected to an external device. The storage 110 may be, for example, a storage area on a cloud.

The ROM 120 is a non-volatile memory capable of holding programs and data even when the power is turned off.

The RAM 130 is a main memory mainly used when the controller 100 performs processing. The RAM 130 is a rewritable memory that temporarily holds programs read from the storage 110 or the ROM 120 and data including a result of the execution.

The display 140 is a display device that can display various types of information and an execution screen. The display 140 may be, for example, a display device such as a Liquid Crystal Display (LCD), an Organic Electro-Luminescence (EL) display, or an electrophoresis display. The display 140 includes an interface to which the display device can be connected. For example, the display 140 may include an external display device connected via a High-Definition Multimedia Interface (HDMI) (trade name), a Digital Visual Interface (DVI), or a Display Port.

The operation inputter 150 is an operation device that allows a user to input an operation. For example, the operation inputter 150 may be an operation device such as a touch panel integrated with the display 140 or an operation button. The operation inputter 150 may be an operation device such as a keyboard or a mouse. The operation inputter 150 may also include an interface (for example, a Universal Serial Bus (USB)) to which an operation device can be connected. For example, a different operation device (an operation device including a touch panel) may be connected to the image forming device 10.

The image former 160 forms an image on, for example, a recording sheet. The image former 160 includes, for example, an image carrier, and forms an image by forming a toner image on the image carrier and transferring the image on the image carrier onto the recording sheet. The image former 160 may be configured as an image forming device such as a printer. The image former 160 may electronically form an image as an image file.

The image scanner 165 scans a document (image) and outputs the document as image data. The image scanner 165 is, for example, a scanner, and may be a scanning device using a Charge Coupled Device (CCD) or a Contact Image Sensor (CIS).

The communicator 170 is a communication interface that communicates with other devices. The communicator 170 may be, for example, a network interface capable of providing wired connection or wireless connection. In the present embodiment, the communicator 170 can communicate with other devices via a network NW.

### 1.3 Software Configuration

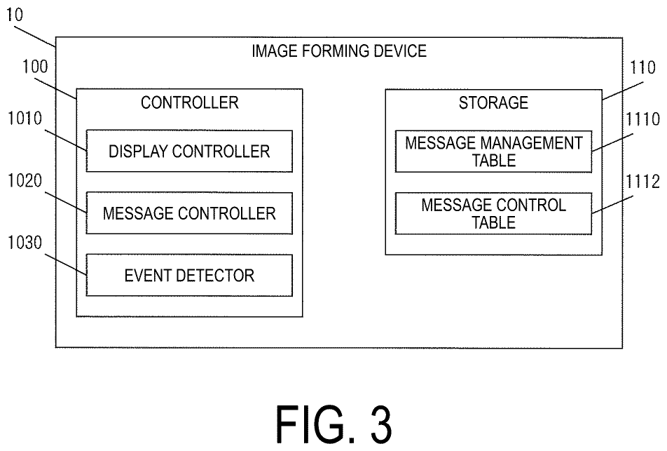

A software configuration of the image forming device 10 will be described with reference to FIG. 3. Note that, in the software configuration illustrated in FIG. 3, configurations necessary for the present embodiment are mainly described, and other configurations are omitted. For example, the image forming device 10 may further include a configuration such as an image processor or a power controller that provides a function necessary for the image forming device 10.

The controller 100 of the image forming device 10 functions as each of the configurations described below by performing a program (application) stored in the storage 110 or the ROM 120.

A display controller 1010 controls the display 140 to display a display screen (first display screen) such as an operation screen or a setting screen. Here, the first display screen may include one or multiple objects selectable by the user, in addition to various types of information.

Here, the objects refer to a button, a numeric keypad, an icon, a keyboard, and the like that are selectable by the user. The objects may include an object operable by any user and an object selectable only by an administrator.

The objects may include an operation target object that is an object to be operated by the user. Further, the objects may include an operation restriction object that is an object that is inoperable by the user.

Further, a message controller 1020 performs control of displaying a message on the display 140. For example, when an event detector 1030 detects an event, the message controller 1020 displays the message on the display 140. In the present embodiment, for example, the message controller 1020 may display a second display screen including the message such that the second display screen is superimposed on the first display screen. The second display screen may be displayed, for example, as a window having a predetermined size and shape. The second display screen may be displayed, for example, in a pop-up manner. For example, the message controller 1020 can change the size of the second display screen in accordance with whether it is necessary to operate an object displayed on the first display screen. In addition, the message controller 1020 can display, in accordance with the type of an event, a message in which an object is further included on the second display screen.

The event detector 1030 detects an event from each function in the image forming device 10. The event detected by the event detector 1030 may be, for example, an event that occurs due to a hardware interrupt, such as out of toner, out of paper, or paper jam. The event detected by the event detector 1030 may be an event that occurs due to a software interrupt such as a user login error or a job setting error.

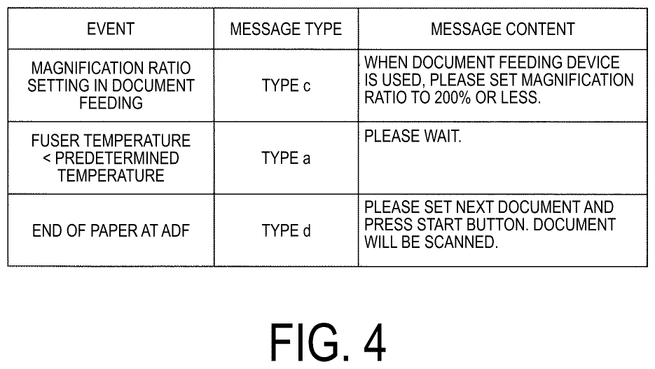

Further, the storage 110 may store a message management table 1110. As shown in FIG. 4, the message management table 1110 is, for example, a table for managing a detected event (for example, “magnification ratio setting in document feeding”), a message type (for example, “type c”), and a message content (for example, “when a document feeding device is used, please set the magnification ratio to 200% or less”).

The message type is information for identifying how to control the message when the message controller 1020 displays the message on the display 140.

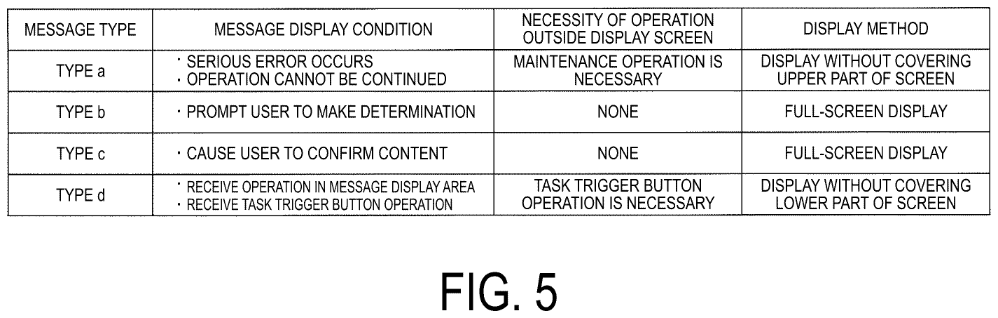

As shown in FIG. 5, a message control table 1112 stores, for example, a message type (for example, “type a”), a message display condition, the necessity of an operation on an object outside the display screen, and a display method of the second display screen in association with one another. The message control table 1112 is used to determine the display method of the second display screen in accordance with whether it is necessary to operate an object on other than the second display screen including the message, that is, whether it is necessary to operate an object displayed on the first display screen.

The controller 100 can determine the size and shape of the second display screen including the message based on the event by referring to the message control table 1112. At this time, the controller 100 can determine the display method of the second display screen in accordance with the message type. For example, in the case of a message the message type of which is a type a and which is displayed when a serious error occurs or when the operation cannot be continued, the controller 100 determines the display method (display size, display position, and the like) of the second display screen such that the second display screen does not cover the display area of an object that needs to be operated to display a maintenance screen. In the case of a message the message type of which is a type d and which is displayed when operations on the first display screen and the second display screen are necessary, the controller 100 determines the display method (display size, display position, and the like) of the second display screen such that the second display screen does not cover the display area of an object (task trigger button that is an execution button for instructing execution of a job in the image forming device 10) displayed on the first display screen. On the other hand, in the case of a message the message type of which is a type b or c and which does not require an operation on an object displayed on the first display screen, the controller 100 determines the display method of the second display screen to be full-screen display.

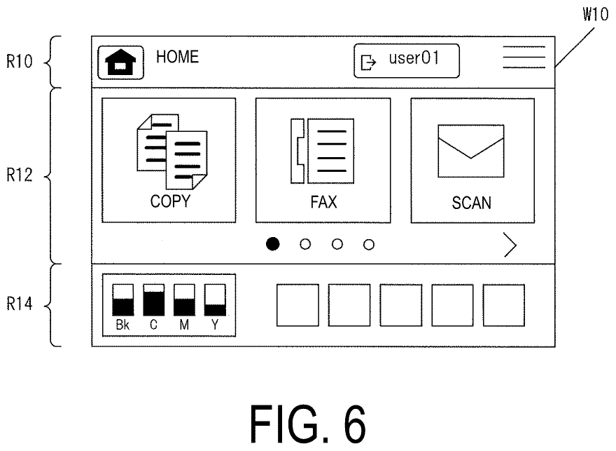

Here, an example of a configuration of the first display screen in the image forming device 10 will be described with reference to FIG. 6. FIG. 6 illustrates an example of a display screen W10 of the image forming device 10 according to the present embodiment.

Here, the display screen W10 (here, the first display screen) may include three areas R10, R12, and R14. The area R12 is an area in which the user mainly performs an operation regarding selection of a function. For example, on a home screen, a mode can be selected. On a mode screen (job execution screen), for example, a job to be executed is set or a destination is set. In the areas R10 and R14, information or an object can be displayed. For example, in the area R10, a button for returning to the home screen may be displayed as an object, or information regarding a logged-in user may be displayed. In the area R10, an operation button for entering a system setting screen may be displayed as an object.

On the home screen, for example, information regarding the remaining toner amount may be displayed in the area R14. In addition, on the mode screen (job execution screen), for example, an operation button for setting the number of copies, an execution button (task trigger button) for instructing execution of a job, and the like may be displayed in the area R14 as objects to be operated. Further, in the area R14, a stop button for stopping execution of a job or a reset button for resetting the setting of a job may be displayed as objects to be operated.

### 1.4 Processing Flow

Now, a processing flow according to the present embodiment will be described with reference to the figures. Note that the processing below will be described with a focus on clarifying the features of the disclosure.

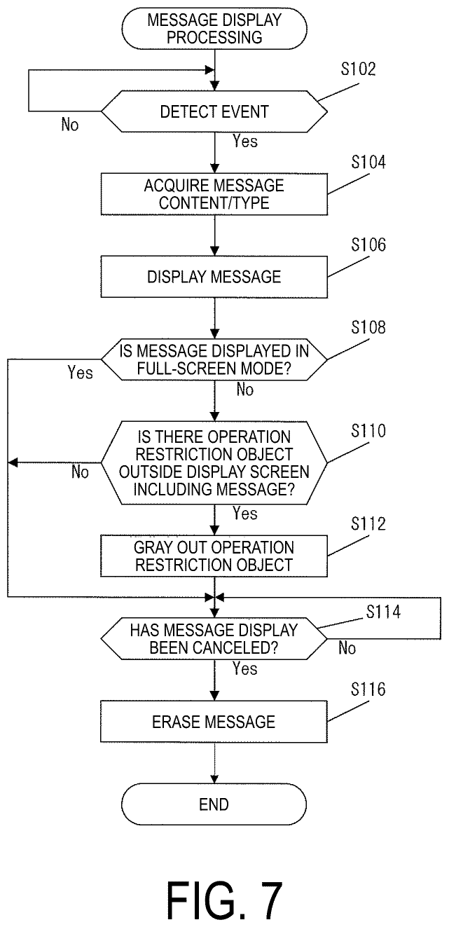

FIG. 7 is a flowchart for describing an operation of message display processing. Note that the following processing may be executed by the display controller 1010 and the message controller 1020 as appropriate, but will be described as being executed by the controller 100 for convenience of description.

First, before this processing is executed, the first display screen is already displayed on the display 140 by the controller 100. The first display screen at this time is referred to as a current first display screen. When an event is detected by the event detector 1030 (Yes in step S102), the controller 100 acquires the message content and the message type based on the detected event (step S104). For example, the controller 100 acquires the message type and the message content of the detected event with reference to the message management table 1110. Thus, the controller 100 determines the second display screen.

The controller 100 refers to the message control table based on the message type corresponding to the event and displays the message acquired in step S104 on the display 140 (step S106). That is, the controller 100 determines the size of the second display screen to be displayed at this time in accordance with whether it is necessary to operate an object included in the currently displayed first display screen.

For example, when there is no object, among objects included in the currently displayed first display screen, that needs to be operated during the display of the second display screen, the controller 100 sets the size of the second display screen to a size that enables full-screen display. The controller 100 determines the size of the second display screen to be a full screen when the message type is the type b or the type c.

When there is an operation target object, among the objects included in the currently displayed first display screen, that needs to be operated during the display of the second display screen based on the event, the controller 100 determines the size of the second display screen such that the second display screen does not include an area in which the operation target object is displayed. The controller 100 determines the size of the second display screen such that the second display screen excludes the area including the operation target object when the message type is the type a or the type d.

In this manner, the controller 100 determines the size of the second display screen while referring to the message control table 1112, and displays the second display screen such that the second display screen is superimposed on the currently displayed first display screen.

The controller 100 determines whether the second display screen is displayed in a full-screen mode (step S108). When the second display screen is not displayed in a full-screen mode (No in step S108), the controller 100 determines whether or not there is an operation restriction object outside the display area of the second display screen (inside an area of the first display screen on which the second display screen is not superimposed) (step S110). That is, it is determined whether or not the operation restriction object is included in the first display screen displayed at a position visible from the user.

Here, full-screen display means to display a window or the like as the second display screen on the entire screen of the display 140. In order to prevent unnecessary information from being displayed to the user at least on the display 140, the controller 100 performs full-screen display by displaying another window or the like in a pop-up manner such that such another window is superimposed in front of the currently displayed operation screen or setting screen. Further, the controller 100 may erase the currently displayed operation screen or setting screen once and display the message (second display screen). When the message is displayed in a window, the controller 100 does not need to necessarily display the message in the entire display area of the display 140. For example, the controller 100 may provide margins at the top, bottom, left, and right of the second display screen and display the second display screen to such an extent that the user cannot visually recognize the operation screen, the setting screen, and the like displayed on the first display screen.

When the operation restriction object is displayed outside the area of the second display screen (Yes in step S110), the controller 100 performs distinguishable display indicating that the operation restriction object is unselectable. For example, in the present embodiment, the controller 100 grays out the operation restriction object (step S112).

Here, the controller 100 determines whether or not the user has performed an operation of canceling the display of the second display screen (step S114). For example, when the second display screen is displayed in a full-screen mode in step S108 (Yes in step S108) or when there is no operation restriction object outside the display area of the second display screen (No in step S110), the processing also transitions to step S114 and is executed.

In order for the controller 100 to determine to cancel the display of the second display screen, for example, it is only necessary to detect that an object (for example, a confirmation button, an erase button, a stop button, a close button, an execution button, or the like) displayed in the second display screen has been selected (operated). Further, the controller 100 may determine to cancel the display of the second display screen when the condition for displaying the message has been no longer satisfied (for example, the temperature of a fuser has reached a predetermined temperature, a paper jam error has been solved, the toner has been refilled, the updating operation has ended, or the like). The controller 100 may also determine to cancel the display of the second display screen when a predetermined time has elapsed after the display of the second display screen.

When it is determined that the display of the second display screen may be canceled, the controller 100 erases the second display screen (Yes in step S114 and proceeding to step S116). As a result, the first display screen is displayed on the display 140.

### 1.5 Screen Example

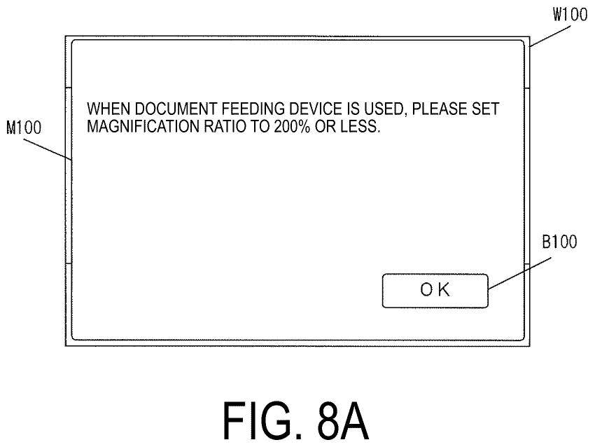

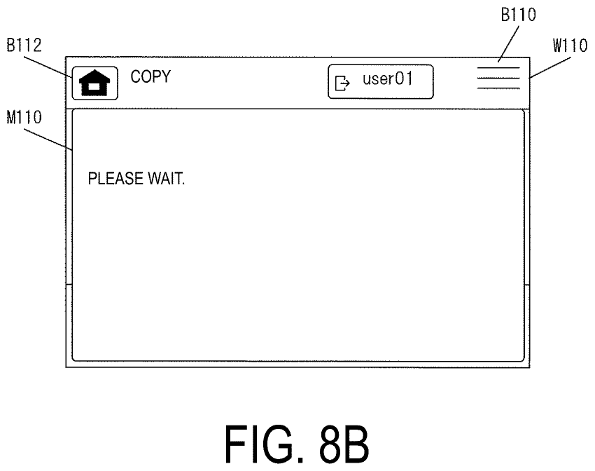

Now, a screen example will be described. FIG. 8A illustrates an example of a display screen W100 when the message type is the type b or the type c. In the display screen W100, a second display screen M100 including the message is displayed in a full-screen mode. Accordingly, the user can confirm the message content included in the second display screen without confusing the content of the originally displayed first display screen and the content of the second display screen. Moreover, on the second display screen M100, a confirmation button B100 is displayed as an object. The user can erase the second display screen M100 by selecting the confirmation button B100.

FIG. 8B illustrates an example of a display screen W110 when the message type is the type a. The display screen W110 is displayed with an upper area not hidden by a second display screen M110. In this case, the user preferably waits for a while until the second display screen M110 disappears. Alternatively, the user may select a home button B112, which is an object displayed outside the display area of the second display screen M110, to perform processing of forcibly returning to the home screen. When the screen returns to the home screen, the second display screen M110 is erased.

In addition, when an administrator who knows a predetermined operation selects an administration button B110 as an object, the screen may transition to an administration screen (for example, a maintenance screen). The administration button B110 may be selectable only when a specific operation different from a normal operation is performed. For example, the screen may transition to the administration screen by the administrator double-tapping the administration button B110 or continuously selecting the administration button for a predetermined time. Further, only when the currently logged-in user is an administrator, the screen may transition to the administration screen. Upon transition to the administration screen, the second display screen M110 is erased.

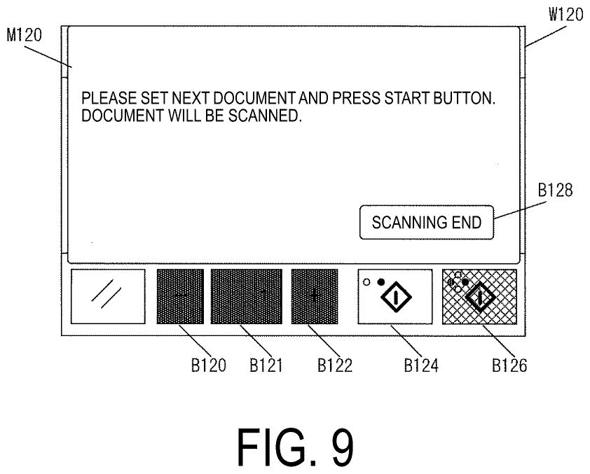

FIG. 9 is an example of a display screen W120 when the message type is the type d. In the display screen W120, a second display screen M120 is displayed so as not to hide a lower area of the first display screen including an object to be operated during the display of the second display screen. In this case, the user may select an end button B128, which is an object displayed on the second display screen M120. For example, in FIG. 9, when the user selects the end button B128, the scanning ends, and the second display screen M120 is erased.

Further, the user may select an object (operation target object) displayed at a lower part of the first display screen outside the display area of the second display screen. In the display screen W120, operation restriction objects are grayed out so as to be unselectable by the user. For example, the user cannot select a button B120 and a button B122. Moreover, when the user selects a button B121, a screen for directly inputting a numerical value is normally displayed. However, since the button B121 is an operation restriction object, the user cannot select the button.

Further, the user can select job execution buttons B124 and B126, which are objects outside the area of the second display screen, in other words, objects displayed on the first display screen. When the job execution buttons are selected by the user, the controller 100 continues to execute a job. For example, in the case of FIG. 9, when the user selects the job execution button B124 (B126), the controller 100 continuously scans a document placed at the image scanner 165 (for example, an ADF). Then, the controller 100 outputs the already read document and the document read after the selection of the job execution button B124 (B126) as one piece of document data. When the end button B128 is selected by the user, the controller 100 outputs the already read document as document data.

### 1.6 Effect

In this manner, when the message is displayed to the user based on the event, the display control device according to the present embodiment can display the user interface that is easy for the user to understand.

In addition, according to the present embodiment, the message can be appropriately displayed on the display with the display mode of the message changed in accordance with the type of the event. As a result, on the display screen, the object that needs to be operated during the message display is displayed in an operable manner even during the message display, and the object that does not need to be operated during the message display is displayed such that its display mode is changed to enable the user to determine that the operation is restricted.

In addition, if an object on which a normal operation can be performed is displayed, the user cannot determine whether or not the object is selectable. Accordingly, the user gets no response when selecting an originally inoperable object and thus is confused as to how to perform the operation. That is, there is a problem in that it is difficult for the user to determine whether or not the operation on the object displayed on the display screen is restricted.

According to the above-described embodiment, an operable object is clearly displayed even during the message display, and an inoperable object is not displayed or is differently displayed in a distinguishable manner during the message display. Thus, the user can perform the operation without being confused.

### 2. Second Embodiment

Next, a second embodiment will be described. In the first embodiment, when an event is detected, the message type is determined from the event and the message is displayed. In the present embodiment, when a message is displayed, the display mode of the message is changed by determining whether or not an operable object or an object that needs to be operated is outside the second display screen.

In the present embodiment, the controller 100 determines the display mode of the second display screen based on an event. Thus, the storage 110 does not need to store the message control table 1112. In addition, for example, the storage 110 may store only a message content based on an event as compared with the message management table 1110. Moreover, when the detected event includes a message or when the controller 100 can acquire a message corresponding to the detected event, the storage 110 does not need to store the message management table 1110.

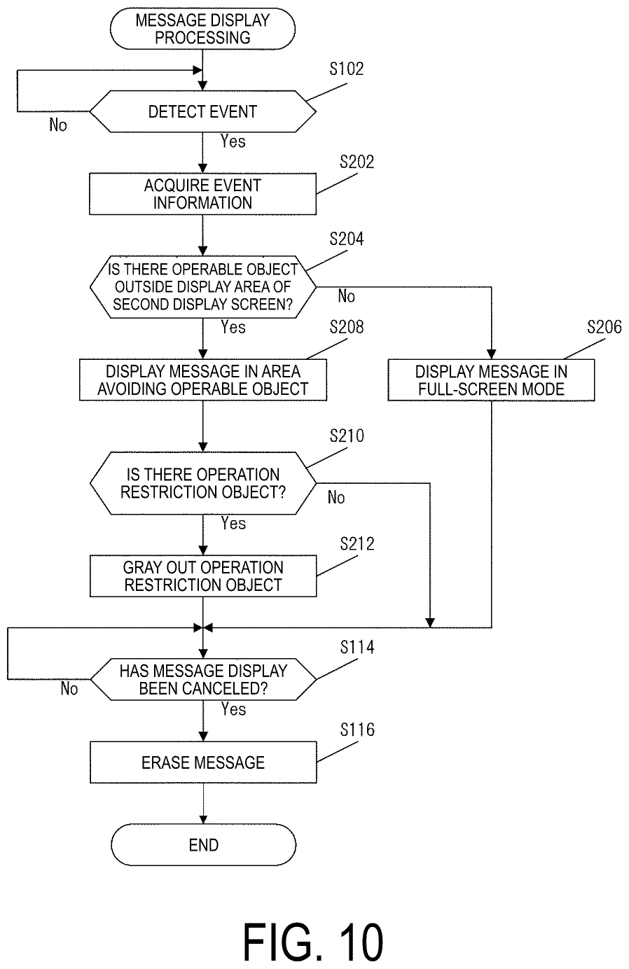

The second embodiment has the same hardware and software configurations as the first embodiment. In the second embodiment, the controller 100 executes, as the message display processing, processing of FIG. 10 instead of the processing of FIG. 7. Hereinafter, differences from the first embodiment will be mainly described, and other processing operations and configurations are substantially the same as those of the first embodiment.

When detecting an event, the controller 100 acquires event information based on the event (Yes in step S102 and proceeding to step S202). The event information includes the type of the event and the message corresponding to the event. In addition, the event information may further include information such as the necessity of an operation on an object included in the first display screen and the necessity of restriction. Further, the event information may include information regarding the second display screen.

When there is no operable object on the first display screen, the controller 100 displays the second display screen including the message in a full-screen mode (No in step S204 and proceeding to step S206).

When there is an operable object or an object that needs to be operated on the first display screen, the controller 100 determines the size of the second display screen such that the second display screen has an area that avoids the object, and displays the second display screen (Yes in step S204 and proceeding to step S208). For example, when there is an operable object in the area R14 of FIG. 6, the controller 100 determines the size of the second display screen to a size that covers the areas R10 and R12, and displays the second display screen such that the second display screen is superimposed on the first display screen. When there is an operable object in the area R10 of FIG. 6, the controller 100 determines the size of the second display screen to a size that covers the areas R12 and R14, and displays the second display screen.

When there is an operation restriction object in an area of other than the second display screen (i.e., an area of the first display screen that is currently visible) (Yes in step S210), the controller 100 grays out the operation restriction object so as to make the operation restriction object unselectable (step S212). The operation restriction object cannot be selected by the user. Thus, the controller 100 distinguishably displays the fact that the operation restriction object is unselectable. When there is no operation restriction object in an area of other than the second display screen, the controller 100 determines whether or not to cancel the message display (No in step S210 and proceeding to step S114).

Here, the second display screen is continuously displayed until the operation of canceling the second display screen is performed or the timing of erasing the second display screen comes (No in step S114). Then, when the user performs the operation of canceling the display of the second display screen or when the timing of canceling the display of the second display screen comes (Yes in step S114), the controller 100 erases the second display screen (step S116).

### 3. Third Embodiment

A third embodiment is an embodiment in which the display mode of the operation restriction object is changed. The third embodiment has the same hardware and software configurations as the first embodiment. Hereinafter, differences from the first embodiment will be mainly described, and other processing operations and configurations are substantially the same as those of the first embodiment.

In step S112 of FIG. 7 in the first embodiment, the operation restriction object is grayed out. In the present embodiment, the operation restriction object is displayed in a different manner in step S112. Note that the same processing can be also achieved in step S212 of FIG. 10 of the second embodiment.

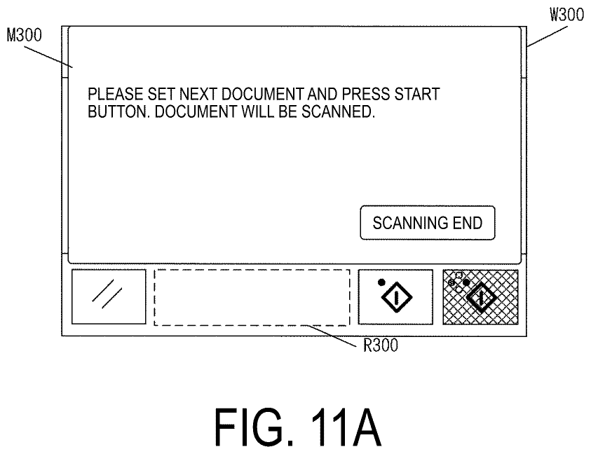

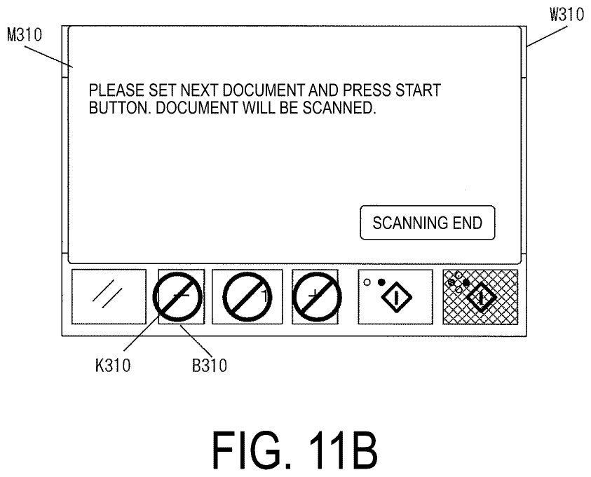

For example, the controller 100 may hide the operation restriction object instead of graying out the operation restriction object. A display screen W300 in FIG. 11A is a screen example with which the display screen W120 of FIG. 9 is replaced.

In the display screen W120 of FIG. 9, the unselectable buttons B120, B121, and B122 are grayed out as examples of the operation restriction objects. In FIG. 11A, as illustrated in an area R300, the buttons, which are grayed out as the restriction objects in FIG. 9, are hidden in FIG. 11A. Thus, it is possible to prevent the user from being confused about how to perform the operation because not knowing whether or not the object is selectable.

FIG. 11B illustrates an embodiment for performing distinguishable display indicating that the operation restriction object is unselectable. For example, the controller 100 displays an operation prohibition mark K310 on a button B310, which is the operation restriction object. An operation on an object on which the operation prohibition mark is displayed is restricted. The operation prohibition mark may be a figure such as an icon or may be a character or a symbol.

Use of the operation prohibition mark is an effective display method, for example, when the screen is an external content (a WEB page or a page of an application added by an add-in) and thus the display mode of the displayed operation restriction object cannot be changed.

### 4. Variations

The disclosure is not limited to the embodiments described above and can be changed in various manners.

In other words, embodiments obtained by combining technical mechanisms appropriately changed without departing from the gist of the disclosure are also included in the technical scope.

In the above-described embodiments, the image forming device has been described as an example of the information processing device. However, the disclosure is applicable to other information processing devices. For example, an example of the information processing device may be a smartphone or a tablet. The information processing device may be a home appliance (for example, an air conditioner, a refrigerator, a television, or the like) equipped with an IoT function. The information processing device is not limited to a stationary device, and may be a portable device or an in-vehicle device, for example. For example, the in-vehicle device may be a device such as a car navigation system.

Although the above-described embodiments have been separately described for convenience of description, the embodiments can be combined and executed within an allowable range. The right of any of the technologies described herein is intended to be acquired through amendment, divisional application, or the like.

The programs running on each device in the embodiments are programs for controlling a CPU or the like (programs for causing a computer to function) to implement the aforementioned functions in the embodiments. Information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to the market, the programs can be stored and distributed in a portable recording medium, or can be transferred to a server computer connected via a network such as the Internet. In this case, it is a matter of course that the storage device of the server device is also included in the disclosure.

Instead of being stored in the device, the above-described data may be stored in an external device and appropriately called. For example, the data may be stored in a Network Attached Storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case where . . . ” and “when . . . ” are described as examples, and the configuration is not limited to the described contents. Configurations not indicated by the descriptions “in a case where . . . ” and “when . . . ” are also disclosed to the extent that the configurations are obvious to a person skilled in the art, and the rights thereof are intended to be acquired.

The processing and the flow of data have been described herein with order, but the order thereof is not limited to the described order. For example, a configuration in which processing is partly removed or the order is rearranged is also disclosed, and the right thereof is intended to be acquired.

Although the functions described in the embodiments are described as being performed in the respective devices, the functions may be implemented in one device or using an external server.

Each functional block or various features of the device used in the above-described embodiments may be implemented or performed by an electric circuit, for example, an integrated circuit or multiple integrated circuits. An electrical circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof. A general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the disclosure can use a new integrated circuit based on the new integrated circuit technology.

### REFERENCE SIGNS LIST

10 Image forming device
100 Controller
110 Storage
120 ROM
130 RAM
140 Display
150 Operation inputter
160 Image former
165 Image scanner
170 Communicator

1. A display control device comprising:
a display that displays a first display screen including an object that is operable;
an operation inputter that receives an operation on the object; and
one or more controllers, wherein
when detecting an event in a state where the first display screen is displayed, the one or more controllers determine a size of a second display screen including a message based on the event in accordance with whether it is necessary to operate the object on the first display screen, and perform control of displaying the second display screen on the display such that the second display screen is superimposed on the first display screen.

2. The display control device according to claim 1, wherein
when it is unnecessary to operate the object on the first display screen, the one or more controllers determine the size of the second display screen to be a size that covers a whole of the first display screen.

3. The display control device according to claim 1, wherein
when it is necessary to operate the object on the first display screen, the controller determines the size of the second display screen to be a size that does not include the object that needs to be operated on the first display screen.

4. The display control device according to claim 3, wherein
when the second display screen is displayed such that the second display screen is superimposed on the first display screen and the object that does not need to be operated on the first display screen is displayed, the one or more controllers display the object in an unselectable manner.

5. The display control device according to claim 4, wherein
the one or more controllers gray out the object that does not need to be operated.

6. The display control device according to claim 4, wherein
the one or more controllers hide the object that does not need to be operated.

7. The display control device according to claim 4, wherein
in a case of the object that does not need to be operated, the one or more controllers perform identification display indicating that an operation is unnecessary.

8. The display control device according to claim 4, wherein
when detecting that a specific operation has been performed on the object that does not need to be operated, the one or more controllers receive the specific operation on the object.

9. The display control device according to claim 1, wherein
when detecting the event, the one or more controllers acquire event information corresponding to the event, and
the event information includes information regarding whether it is necessary to operate the object on the first display screen.

10. The display control device according to claim 9, wherein
the event information includes information regarding the message, and
the one or more controllers include, in the second display screen, the message included in the event information.

11. A display control method in a display control device including a display that displays a first display screen including an object that is operable, an operation inputter that receives an operation on the object, and one or more controllers, the display control method comprising:
when an event is detected in a state where the first display screen is displayed, determining a size of a second display screen including a message based on the event in accordance with whether it is necessary to operate the object on the first display screen, and performing control of displaying the second display screen on the display such that the second display screen is superimposed on the first display screen.
